(19) United States
(12) Patent Application Publication
(10) Pub. No.: US 2026/0200384 A1
(43) Pub. Date: Jul. 16, 2026

(54) METHODS FOR OPERATING A VEHICLE COMFORT SYSTEM, AND VEHICLE COMFORT SYSTEM

(71) Applicant: Faurecia Autositze GmbH, Hannover (DE)

(72) Inventors: Piotr Ceglarek, Katowice (PL); Adrian Malik, Wroclaw (PL); Marcin Pajdak, Mieroszow (PL); Edwin Valencia Rodriguez, Szczawno Zdroj (PL)

(73) Assignee: Faurecia Autositze GmbH, Hannover (DE)

(21) Appl. No.: 19/447,155

(22) Filed: Jan. 13, 2026

(30) Foreign Application Priority Data
Jan. 14, 2025 (DE) 102025101171.0

(51) Int. Cl. B60N 2/90; B60R 16/023; F15B 13/04; F15B 21/00

(52) U.S. Cl. CPC B60N 2/976; B60R 16/0231; F15B 13/0401; F15B 21/005; F15B 2211/427

(57) ABSTRACT

A vehicle comfort system having a vehicle seat with one or more fluid-fillable bladders, a control system and, for each bladder, at least one valve controlled by the control system by PWM signals. The control system controls the filling or emptying of the bladder(s) according to program information by opening a valve according to the program information by a PWM signal within a time interval so that a fluid flows into the associated bladder and the internal pressure of the bladder is increased to an upper setpoint. The fluid can escape from the bladder and the internal pressure within the bladder can be decreased to a lower setpoint. Within the time interval, the control system opens and closes a valve associated with a bladder, in an oscillating manner by at least one sequence of PWM signal pulses, which are preferably short in duration compared to the time interval.

### BACKGROUND OF THE INVENTION

### Technical Field

The invention relates to a method for operating a vehicle comfort system. Vehicle comfort systems typically comprise vehicle seats with fluid-fillable bladders that are housed in the seat parts and/or backrests thereof and can be evacuated and/or filled by a control system in order to implement seat adjustments or a massage function.

### Prior Art

In massage systems, the periodic filling and emptying of the fluid-fillable bladders ensures that a person sitting in such an equipped vehicle seat feels local pressure on the back or another body part. Additionally, devices separate from the vehicle comfort system can generate vibrations, which, for example, provide an additional haptic impression in the form of oscillations when playing music from the vehicle entertainment system. Examples of such separate systems that can generate oscillations can be found, for example, in EP 4227154 B1, US2022/0363172 A1, or DE102024001017 A1.

Systems for additional oscillations that are perceived by the vehicle occupant are comparatively complex to install, since separate devices must be installed in the vehicle seat for this purpose. Typically, such additional systems are found exclusively in the lumbar region of a vehicle seat.

The object of the present invention is therefore to create a method for operating a vehicle comfort system as well as a vehicle comfort system itself, in which additional components for generating oscillations can be dispensed with.

### BRIEF SUMMARY OF THE INVENTION

This object is achieved by a method for operating a vehicle comfort system, which comprises a vehicle seat with one or more fluid-fillable bladders housed in the seat part and/or backrest thereof, a control system, and for each bladder, at least one corresponding valve controlled by the control system by means of PWM signals generated by it, wherein the control system controls the filling or emptying of the fluid-fillable bladder(s) according to specified program information by opening a controlled valve according to the program information by means of a PWM signal within a time interval so that a fluid flows into the associated bladder and the internal pressure of the bladder is thus increased to an upper setpoint, or escapes from the bladder and the internal pressure within the bladder is thus decreased to a lower setpoint, wherein, within the time interval, the control system opens and closes a valve associated with a bladder, in an oscillating manner by means of at least one sequence of PWM signal pulses, which are preferably short in duration in comparison to the time interval

The object is achieved as well as by a vehicle comfort system for carrying out a method as disclosed herein, which comprises a vehicle seat with one or more fluid-fillable bladders housed in the seat part and/or backrest thereof, a control system, and for each bladder, a corresponding first valve controlled by the control system by means of PWM signals generated by it, for filling the bladder, a pump for supplying the bladders with fluid, preferably air, and optionally, for each bladder, a corresponding second valve controlled by the control system by means of PWM signals generated by it, for emptying the bladder, wherein the first valve is arranged such that, in a first switching position, it opens a flow path between the pump and the associated bladder and, in a second switching position, it closes this flow path.

Advantageous embodiments are found in the respective dependent claims.

The invention utilizes existing systems of fluid-fillable bladders and an existing control system thereof to create the impression of a vibration for the vehicle occupant by means of a sequence of PWM pulses that are short in duration in comparison to the usual filling time.

This means, on the one hand, that additional installations for implementing a vibration function are unnecessary and, on the other hand, that the vibration is not limited to the lumbar region of a vehicle seat. In addition, program information in the control system of the fluid-fillable bladders can also be used to generate a haptic warning signal in order to attract the attention of the vehicle occupant.

According to the invention, a method for operating a vehicle seat comfort system is proposed, wherein the vehicle seat comfort system comprises

i) a vehicle seat with one or more fluid-fillable bladders housed in the seat part and/or backrest thereof,

ii) a control system, and

iii) for each bladder, at least one corresponding valve controlled by the control system by means of PWM signals generated by it.

According to the method according to the invention, it is provided that the control system controls the filling or emptying of the fluid-fillable bladder according to specified program information by opening a controlled valve according to the program information by means of a PWM signal within a time interval. This causes a fluid, preferably air, to flow into the associated bladder so that the internal pressure of the bladder is increased to an upper setpoint, or to escape from the bladder so that the internal pressure within the bladder is decreased to a lower setpoint.

filling or emptying of a fluid-fillable bladder, which the vehicle occupant perceives as a vibration on the body.

It is preferably provided that the PWM signal pulses used for oscillating operation have a pulse length between 40 ms and 150 ms, preferably between 40 ms and 100 ms, more preferably between 50 ms and 70 ms, most preferably 60 ms. In contrast, the time within which a fluid-fillable bladder is completely filled or emptied is typically on the order of 1-3 seconds. In principle, the PWM signal pulses can have the same length, but different lengths are also possible. Basically, the method according to the invention modulates a standard filling process or emptying process, which opens and closes a valve by means of a PWM signal, by using short PWM signal pulses in comparison to the total filling duration or emptying duration.

Between two successive PWM signal pulses, the valve is preferably closed for a time period of 30 ms to 80 ms, preferably 50 ms to 70 ms, most preferably 60 ms. In this way, vibrations are perceived particularly intensely. Typically, the pressure increases continuously from the opening of the valve until the closing of the valve and then decreases slightly when the valve closes since some of the air escapes from the bladder into the surrounding pneumatic system or into the environment when the valve closes. In this way, oscillations arise in the time curve of the internal pressure within a bladder.

The type, duration, and timing of the PWM signal pulse sequence can vary depending on the application. For example, it is possible to generate vibrations throughout the entire duration of the filling process or only at the beginning or end of the filling process. The same applies when emptying the bladder. It is also possible to generate vibrations only in a portion of the filling process, for example in the middle of it. The same applies to emptying the bladder.

Preferred variants of the method according to the invention therefore provide that the bladder(s) are filled according to the specified program information within the time

a) opens and closes a first valve associated with a bladder, with at least one sequence of PWM signal pulses during the first time period;

b) opens and closes a second valve associated with a bladder, with at least one sequence of PWM signal pulses during the second time period.

It may be provided that, over the entire course of the first and/or the second time period, the first valve or the second valve is opened and closed in an oscillating manner by means of the sequence of PWM signal pulses.

Another possible variant of the method according to the invention provides that the first valve or the second valve is opened and closed by means of a sequence of PWM signal pulses in an early range of the first and/or the second time period and/or by means of a further sequence of PWM signal pulses in a later range of the first and/or the second time period or by means of a sequence of PWM signal pulses in a middle range of the first and/or the second time period.

Other variants are of course also conceivable and not excluded.

Alternatively or additionally, the control system according to the invention makes it possible at any time to send haptic signals via vibrations in order to give the vehicle occupant a warning or the like.

Furthermore, it is possible for the control system to control multiple bladders in the ways mentioned above, wherein, for example, it may be provided to make the vibrations of multiple bladders occur simultaneously or at different times.

The invention further relates to a vehicle comfort system for carrying out a method according to one of the preceding claims, which comprises

i) a vehicle seat with one or more fluid-fillable bladders housed in the seat part and/or backrest thereof,

ii) a control system, and

iii) for each bladder, a corresponding first valve controlled by the control system by means of PWM signals generated by it, for filling the bladder,

v) optionally, for each bladder, a corresponding second valve controlled by the control system by means of PWM signals generated by it, for emptying the bladder.

The first valve is arranged such that, in a first switching position, it opens a flow path between the pump and the associated bladder and, in a second switching position, it closes this flow path.

According to a preferred embodiment of the present invention, the bladders, the pump, the control system, and the valves are part of a seat massage system, wherein the control system comprises program information with at least one massage program.

### BRIEF DESCRIPTION OF THE DRAWINGS

The invention is explained in more detail below with reference to FIG. 1‑15 and the exemplary embodiments contained therein.

FIG. 1 shows a perspective view of a vehicle seat,

FIG. 2 shows a possible circuit for supplying a fluid-fillable bladder in a first switching state,

FIG. 3 shows the circuit for supplying a fluid-fillable bladder in a second switching state,

FIG. 4 shows an alternative circuit for supplying a fluid-fillable bladder,

FIG. 5 schematically shows a typical time curve of a PWM signal for generating vibrations in a fluid-fillable bladder,

FIG. 6 schematically shows a typical time curve of the internal pressure of a fluid-fillable bladder in accordance with a first method variant,

FIG. 7 shows a time curve of PWM signal pulses for generating the pressure curve in the time range T₁ of FIG. 6,

FIG. 8 schematically shows a typical time curve of the internal pressure of a fluid-fillable bladder in accordance with a second method variant,

FIG. 9 shows a time curve of PWM signal pulses for generating the pressure curve in the time range T₁ of FIG. 8,

FIG. 10 schematically shows a typical time curve of the internal pressure of a fluid-fillable bladder in accordance with a third method variant,

FIG. 11 shows a time curve of PWM signal pulses for generating the pressure curve in the time range T₁ of FIG. 10,

FIG. 13 shows a time curve of PWM signal pulses for generating the pressure curve in the time range T₁ of FIG. 12,

FIG. 14 schematically shows a typical time curve of the internal pressure of a fluid-fillable bladder in accordance with a fifth method variant, and

FIG. 15 shows a time curve of PWM signal pulses for generating the pressure curve in the time range T₁ of FIG. 14.

### DETAILED DESCRIPTION OF PREFERRED EMBODIMENTS

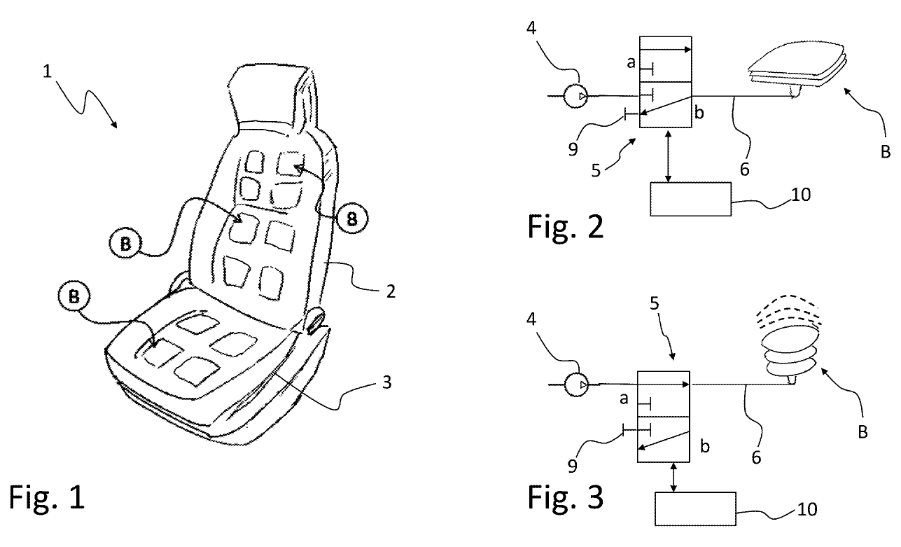

FIG. 1 shows a motor vehicle seat 1 with a backrest 2 and a seat part 3, which is equipped with a vehicle seat comfort system. This vehicle seat comfort system inter alia comprises fluid-fillable bladders B, which are primarily used as a massage system for massaging a seat occupant. This is achieved by filling and emptying the fluid-fillable bladders according to specified program information stored in a control system (not shown here) of the vehicle seat comfort system.

For this purpose, a corresponding valve is opened and closed in each case. FIGS. 2 and 3 show different switching positions of such a valve 5. 4 denotes a pump that supplies a pneumatic system with a fluid, preferably air. In FIG. 2, the valve 5 is switched to the switching position b, i.e., the valve is closed since the supply line 6 to the fluid-fillable bladder B is blocked by the blocking device 9. The switching of the valve 5 is carried out via the aforementioned control system 10 according to specified program information.

FIG. 3 shows the arrangement of FIG. 2 in the open switching position a. The fluid from the pump 4 passes through the valve 5 into the line 6 and from there into the bladder B. By means of a PWM signal, which is sent from the control system 10 to the valve 5, the valve 5 is switched from the closed position shown in FIG. 2 to the open position shown in FIG. 3 when a threshold voltage or threshold current is exceeded, as long as the PWM signal provides voltage values or current values above the mentioned threshold value. If the PWM signal drops below the mentioned threshold value, the closed position b in FIG. 2 is assumed. A PWM signal oscillating around the threshold value thus ensures that the valve 5 is alternately opened and closed.

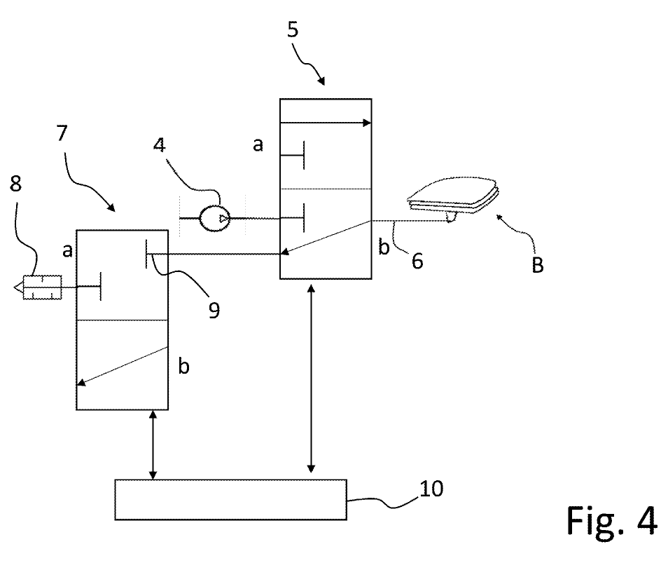

FIG. 4 shows an extended representation of such a valve arrangement as shown in FIGS. 2 and 3.

The blocking device 9 is here part of the closed switching position a of a second valve 7. The second valve 7 is connected to the first valve 5 and its switching position b so that, when the valve 5 assumes the switching position b, the line 6 carries fluid from the bladder B to the valve 7. If the valve 7 is switched to its open switching position b by means of the control system 10, which is again achieved by means of a PWM signal, the fluid flows from the bladder B through the valve 5 and the valve 7 to the fluid outlet 8 and thus into the environment. This switching position is used to drain fluid from the bladder B. This circuit can also be used to open and close the valve 7 by means of a pulse sequence of PWM signals in rapid succession during emptying. In this way, it is possible to generate appropriate vibrations not only when filling but also (alternatively or additionally) when emptying the bladder B, if desired.

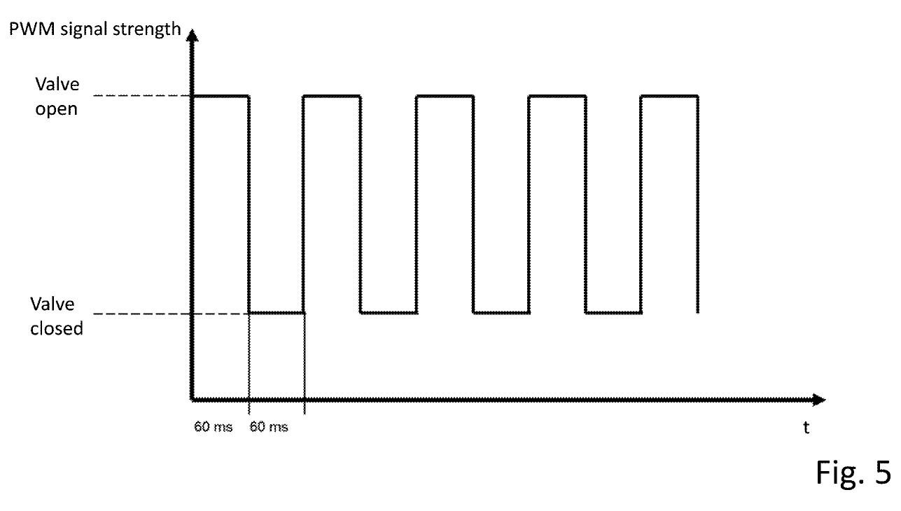

FIG. 5 shows a typical PWM signal over time. It consists of a series of rectangular pulses (other geometries are also conceivable) that oscillate around a trigger threshold value required to open the corresponding valve 5, 7. The pulse duration or the interval between two successive pulses is preferably in the range of a few tens of ms, the interval between the pulses is preferably about 60 ms, i.e., the range in which the valve is (temporarily) closed, while the duration of the pulses, i.e., the time range within which the valve is open, is approximately 40-150 ms. The example shown illustrates a pulse length of 60 ms by way of example. This sequence of pulses is used to achieve the vibration of a fluid-fillable bladder. It is understood that the intervals between the pulses, as well as their length, can also vary within the sequence.

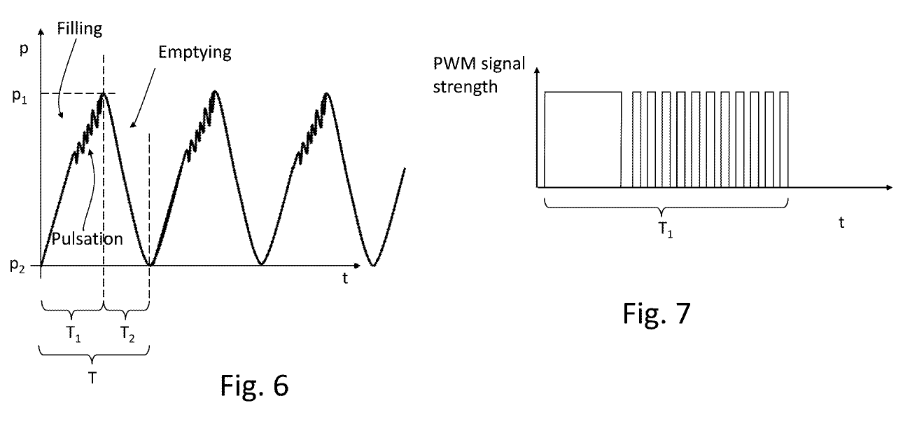

FIGS. 6-15 by way of example illustrate some possible embodiments of the method according to the invention.

FIG. 6 shows a first method variant; shown is the pressure curve of the internal pressure in a fluid-fillable bladder as a function of time. Initially, there is a signal increase between a lower pressure setpoint p₂ and an upper pressure setpoint p₁, which are specified, for example, by the control system. Typically, as is common with massage programs, a bladder is periodically filled and emptied, i.e., a cycle of filling/emptying a bladder is completed within a time interval T and then repeats periodically. The bladder is accordingly filled in the subinterval T₁ and emptied in the subinterval T₂. This process is basically the same for the other exemplary embodiments. This process is specified by program information stored in the control system. Accordingly, the control system works by opening and closing the valve 5 or 7 (cf. FIGS. 2-4).

FIG. 6 shows that the pressure curve rises continuously initially and oscillates in the last third of the subinterval T₁. This is achieved by transmitting a corresponding PWM signal, which qualitatively has the shape shown in FIG. 7, to the associated valve. At the beginning, a PWM pulse with a relatively long duration is sent, resulting in a continuous increase in the internal pressure of the bladder in the first phase of the subinterval T₂. Accordingly, the short-duration PWM pulses shown in FIG. 7 cause the valve to open and close in rapid succession, which is then noticeable as oscillations in the pressure curve in accordance with FIG. 6 and as a pulsating massage or vibrations for the vehicle occupant.

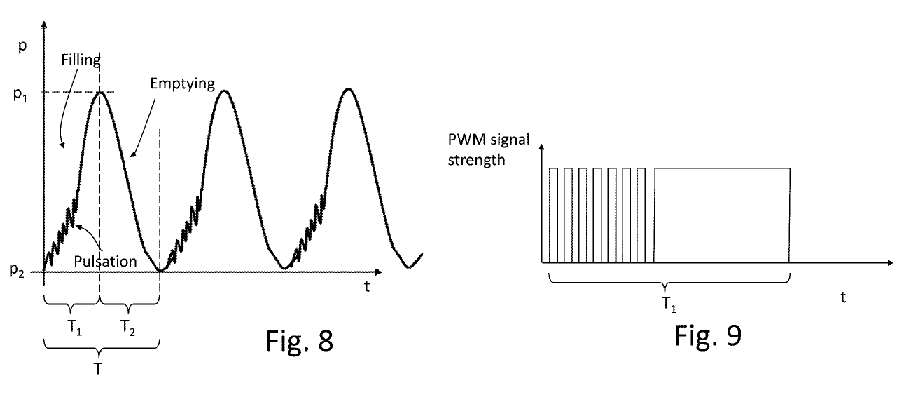

FIGS. 8 and 9 show a second method variant, which differs from the embodiment in accordance with FIGS. 6 and 7 only in that oscillations ensure the pulsation of a fluid-fillable bladder in approximately the first third of the filling process, while a continuous filling process is carried out via a longer PWM pulse in the further course of the subinterval T₁.

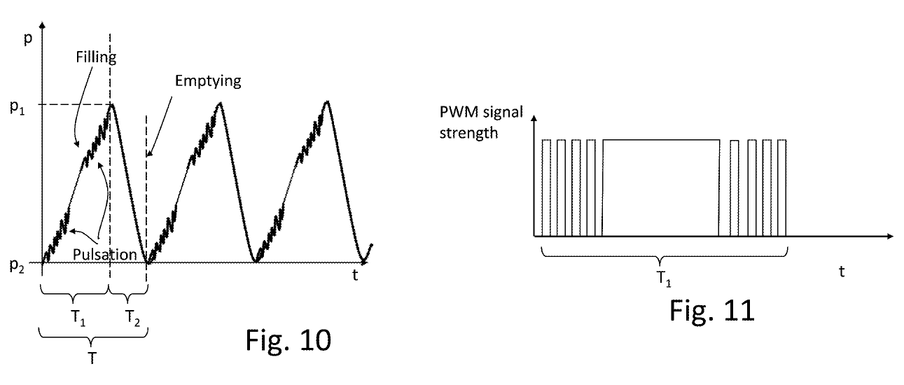

It is also possible to ensure appropriate pulsation at the beginning and end of a filling process and to achieve a continuous pressure increase in between. This is shown in FIG. 10; a PWM signal with which something like this can be achieved can be found in FIG. 11.

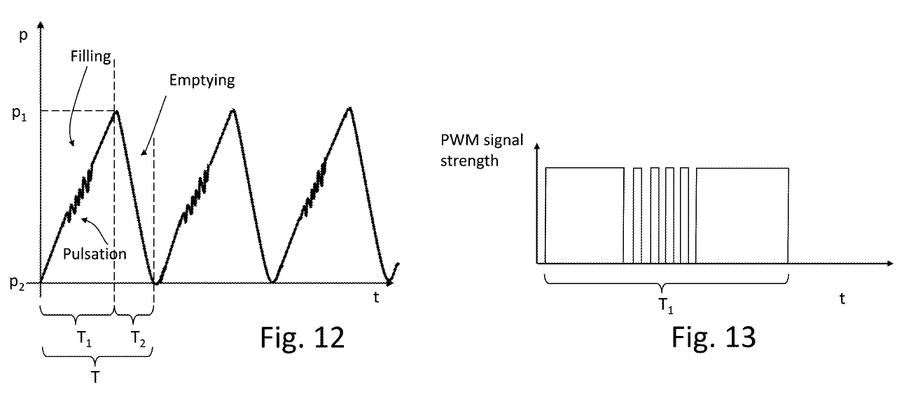

Conversely, as can be seen in FIGS. 12 and 13, it is also conceivable to carry out a continuous filling of a bladder at the beginning and at the end of the subinterval T₁ and to have the bladder pulsate only in the time in between.

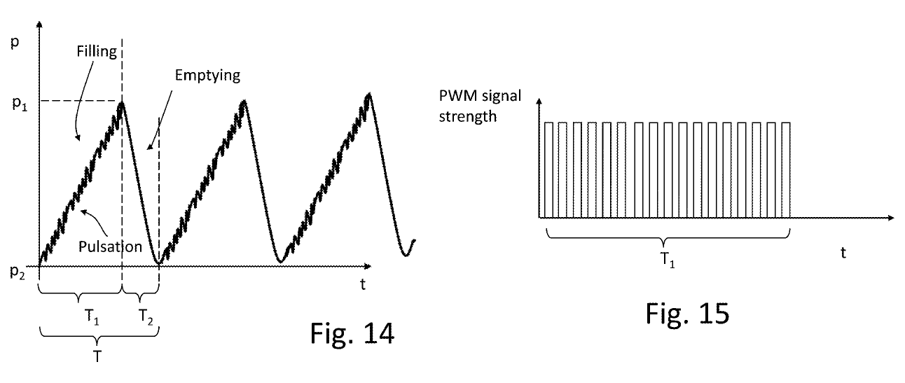

Finally, it is also possible to carry out the pulsation of the bladder over an entire subinterval T₁, as indicated in FIGS. 14 and 15.

In all these embodiments, the valve 5 is moved back and forth between the switching positions a and b (cf. FIGS. 2, 3, and 4) by the control system 10 and is thereby opened and closed.

It is understood that the aforementioned examples can be carried out alternatively or additionally during the emptying of a bladder in the subinterval T₂. In this case, the valve 7 shown in FIG. 4 would be opened and closed alternately, while the valve 5 is held in the switching position b.

With the present invention, it is possible to provide the vehicle occupant with an additional pulsating effect during a seat massage, which expands the range of possible massages. At the same time, the equipment configuration also makes it possible to send haptic signals in order to alert the vehicle occupant to dangers or the like, for example.

A particular advantage here is that no additional installations are required in a vehicle seat comfort system; instead, the existing components can be used. This primarily saves costs and installation space, and existing systems can be retrofitted, for example, through a software update for the massage programs.

### List of reference signs:

1 Vehicle seat

2 Backrest of 1

3 Seat part of 1

4 Pump

5 First valve

6 Fluid line from 5 to B

7 Second valve

8 Fluid outlet

9 Blocking device

10 Control system

B Fluid-fillable bladder

T Time interval

T₁ First subinterval of T

T₂ Second subinterval of T

a First switching position of 5, 7

b Second switching position of 5, 7

p Internal pressure of B

p₁ Upper pressure setpoint

p₂ Lower pressure setpoint

t Time

What is claimed is:

1. A method for operating a vehicle comfort system, which comprises
i) a vehicle seat (1) with one or more fluid-fillable bladders (B) housed in the seat part (3) and/or backrest (2) thereof,
ii) a control system (10), and
iii) for each bladder (B), at least one corresponding valve (5, 7) controlled by the control system (10) by means of PWM signals generated by it,
wherein the control system (10) controls the filling or emptying of the fluid-fillable bladder(s) (B) according to specified program information by opening a controlled valve (5, 7) according to the program information by means of a PWM signal within a time interval (T) so that a fluid flows into the associated bladder (B) and the internal pressure of the bladder (B) is thus increased to an upper setpoint (p1), or escapes from the bladder (B) and the internal pressure within the bladder (B) is thus decreased to a lower setpoint (p2), wherein, within the time interval (T), the control system (10) opens and closes a valve (5, 7) associated with a bladder (B), in an oscillating manner by means of at least one sequence of PWM signal pulses, which are preferably short in duration in comparison to the time interval (T).

2. The method according to claim 1, in which the PWM signal pulses used for oscillating operation have a pulse length between 40 ms and 150 ms, preferably between 40 ms and 100 ms, more preferably between 50 ms and 70 ms, most preferably 60 ms.

3. The method according to claim 1, wherein between two successive PWM signal pulses, the valve (5, 7) is closed for a time period of 30 ms to 80 ms, preferably 50 ms to 70 ms, most preferably 60 ms.

4. The method according to claim 1, wherein the bladder(s) (B) are filled according to the specified program information within the time interval (T) during a first time period (T1) and emptied again during a second time period (T2), wherein the control system (10):
a) opens and closes a first valve (5) associated with a bladder (B), with at least one sequence of PWM signal pulses during the first time period (T1);
b) opens and closes a second valve (7) associated with a bladder (B), with at least one sequence of PWM signal pulses during the second time period (T2).

5. The method according to claim 4, wherein over the entire course of the first (T1) and/or the second time period (T2), the first valve (5) or the second valve (7) is opened and closed in an oscillating manner by means of the sequence of PWM signal pulses.

6. The method according to claim 4, wherein
the first valve (5) or the second valve is opened and closed by means of a sequence of PWM signal pulses in an early range of the first (T1) and/or
the second time period (T2) and/or by means of a further sequence of PWM signal pulses in a later range of the first (T1) and/or the second time period (T2) or by means of a sequence of PWM signal pulses in a middle range of the first (T1) and/or the second time period (T2).

7. A vehicle comfort system for carrying out a method according to claim 1, the system comprising
i) a vehicle seat (1) with one or more fluid-fillable bladders (B) housed in the seat part (3) and/or backrest (2) thereof,
ii) a control system (10), and
iii) for each bladder (B), a corresponding first valve (5) controlled by the control system (10) by means of PWM signals generated by it, for filling the bladder (B),
iv) a pump (4) for supplying the bladders with fluid, preferably air, and
v) optionally, for each bladder (B), a corresponding second valve (7) controlled by the control system (10) by means of PWM signals generated by it, for emptying the bladder (B),
wherein the first valve (5) is arranged such that, in a first switching position (a), it opens a flow path between the pump (4) and the associated bladder (5) and, in a second switching position (b), it closes this flow path.

8. The vehicle comfort system according to claim 7, wherein the bladders (B), the pump (4), the control system (10), and the valves (5, 7) are part of a seat massage system, wherein the control system (10) comprises program information with at least one massage program.

9. The vehicle comfort system according to claim 7, wherein the second valve (7) is fluidically connected to the first valve (5) such that, in the second switching position (b) of the first valve (5), it closes a flow path between the bladder (B) and a fluid outlet (8) connected to the second valve (7) and, in a second switching position (b) of the second valve (7), it opens this flow path.
